(19) United States
(12) Patent Application Publication
(10) Pub. No.: US 2023/0060754 A1
(43) Pub. Date: Mar. 2, 2023

(54) THERMAL INTERFACE MATERIAL COMPRISING MULTIMODALLY DISTRIBUTED SPHERICAL FILLERS

(71) Applicant: DDP SPECIALTY ELECTRONICS MATERIALS US, LLC, Wilmington, DE (US)

(72) Inventors: Nina Hillesheim, Freienbach (CH); Sergio Grunder, Freienbach (CH); Andreas Lutz, Freienbach (CH); Michelle Kuster, Freienbach (CH); Sophie Lutz, Freienbach (CH); Felix Koch, Freienbach (CH)

(21) Appl. No.: 17/796,351

(22) PCT Filed: Mar. 24, 2021
(86) PCT No.: PCT/US2021/023873

§ 371 Date: Jul. 29, 2022

Related U.S. Application Data
(60) Provisional application No. 63/000,227, filed on Mar. 26, 2020.

(51) Int. Cl. H01M 10/653; H01M 10/613; C09K 5/14; C08K 7/18

(52) U.S. Cl. CPC H01M 10/653; C08K 7/18; C09K 5/14; H01M 10/613; C08K 2201/001; C08K 2201/005; C08K 2201/014; H01M 2220/20

(57) ABSTRACT

Disclosed herein are thermal interface materials comprising thermoset binder component and a mixture of spherically shaped and thermally conductive fillers and the use thereof in battery powered vehicles.

### FIELD OF DISCLOSURE

The disclosure relates to thermal interface materials and their use in battery powered vehicles.

### BACKGROUND

Compared to traditional modes of travel, battery powered vehicles offer significant advantages, such as light weight, reduced CO₂ emission, etc. However, to ensure optimal use of the technology, a number of technological problems still need to be overcome. For example, one current effort in the industry is to increase the driving distance of battery powered vehicles by developing batteries with higher energy density. And this leads to the need to develop better thermal management systems for high energy density batteries.

In battery powered vehicles, battery cells or modules are thermally connected to cooling units by thermal interface materials (TIM). Such TIM are typically formed of polymeric materials filled with thermally conductive fillers. One way to obtain TIM with higher thermal conductivity is to incorporate higher loadings of thermally conductive fillers. However, higher loadings of fillers also cause the viscosity of the TIM too high to be useful. Thus, there is still a need to develop TIM that is high in thermal conductivity and low in viscosity.

### SUMMARY

In a first aspect, the invention provides thermal interface material compositions comprising: a) a polymeric binder component, and b) about 85-95 wt% of a mixture of spherically shaped and thermally conductive fillers, with the total weight of the composition totaling to 100 wt%, and wherein, the mixture of spherically shaped and thermally conductive fillers comprises, based on the combined weight thereof, i) about 15-40 wt% of a first thermally conductive filler that has a spherical shape and a particle size distribution D₅₀ ranging from about 0.1-20 µm, and ii) about 50-80 wt% of a second thermally conductive filler that has a spherical shape and a particle distribution size D₅₀ ranging from about 40-150 µm.

In a second aspect, the invention provides thermal interface material compositions comprising: a) a polymeric binder component, and b) about 85-95 wt% of thermally conductive fillers, with the total weight of the composition totaling to 100 wt%, and wherein, the thermally conductive fillers comprises, based on the combined weight thereof, i) about 0.5-10 wt% of a first thermally conductive filler that has a spherical or non-spherical shape and a particle size distribution D₅₀ ranging from about 0.1-2 µm, ii) about 10-35 wt% of a second thermally conductive filler that has a spherical shape and a particle size distribution D₅₀ ranging from about 3-10 µm, and iii) about 50-80 wt% of a third thermally conductive filler that has a spherical shape and a particle distribution size D₅₀ ranging from about 40-150 µm.

In one embodiment of the thermal interface material composition, the composition comprises about 1-10 wt% of the polymeric binder component, based on the total weight of the composition.

In a further embodiment of the thermal interface material composition, the first, second and third thermally conductive filler are independently selected from the group consisting of Al₂O₃, Al, Mg(OH)₂, MgO₂, SiO₂, Boron nitride, and mixtures thereof. In the second aspect of the invention, the first spherical or non-spherical thermally conductive filler i) may be selected from Al₂O₃, Al, TiO₂, ZnO, Mg(OH)₂, MgO₂, SiO₂, Boron nitride, Al(OH)₃ (aluminium hydroxide) and mixtures thereof.

In a yet further embodiment of the thermal interface material composition, the first, second and third thermally conductive filler are Al₂O₃ particles.

In another embodiment of the second aspect, the first thermally conductive filler i) is selected from Al₂O₃, aluminium hydroxide and mixtures of these.

In a preferred embodiment of the second aspect, the first thermally conductive filler i) is selected from Al₂O₃, aluminium hydroxide and mixtures of these, and the second thermally conductive filler ii) is Al₂O₃.

In another preferred embodiment of the second aspect, the first thermally conductive filler i) is selected from Al₂O₃, aluminium hydroxide and mixtures of these, the second thermally conductive filler ii) is Al₂O₃, and the third thermally conductive filler iii) is Al₂O₃.

In a yet further embodiment of the thermal interface material composition of the first aspect, the first thermally conductive filler has a particle size distribution D₅₀ ranging from about 0.5-15 µm, and the second thermally conductive filler has a particle distribution size D₅₀ ranging from about 40-120 µm.

In a yet further embodiment of the thermal interface material composition of the second aspect, the first thermally conductive filler i) has a particle size distribution D₅₀ ranging from about 0.5-15 µm, more preferably 0.6-2 µm.

In a yet further embodiment of the thermal interface material composition of the second aspect, the second thermally conductive filler ii) has a particle size distribution D₅₀ ranging from about 3-10 µm, preferably 3-6 µm.

In a yet further embodiment of the thermal interface material composition of the second aspect, the third thermally conductive filler iii) has a particle size distribution D₅₀ ranging from about 40-150 µm, preferably 50-100 µm, more preferably 55-85 µm.

In a yet further embodiment of the thermal interface material composition of the first aspect, the second thermally conductive filler has a particle distribution size D₅₀ ranging from about 40-90 µm.

In a yet further embodiment of the thermal interface material composition of the first aspect, the composition comprises about 18-38 wt% of the first thermally conductive filler and about 50-78 wt% of the second thermally conductive filler, based on the total weight of the composition.

In a yet further embodiment of the thermal interface material composition of the first aspect, the composition comprises about 20-35 wt% of the first thermally conductive filler and about 53-75 wt% of the second thermally conductive filler, based on the total weight of the composition.

In a yet further embodiment of the thermal interface material composition of the second aspect, the composition comprises about 1-7, more preferably 2-5 wt% of the first thermally conductive filler, based on the total weight of the composition.

In a yet further embodiment of the thermal interface material composition of the second aspect, the composition comprises about 10-30, more preferably 12-28 wt% of the second thermally conductive filler, based on the total weight of the composition.

In a yet further embodiment of the thermal interface material composition of the second aspect, the composition comprises about 50-75, more preferably 50-68 wt% of the third thermally conductive filler, based on the total weight of the composition.

In a yet further embodiment of the thermal interface material composition of the second aspect, the composition comprises about 2-5 wt% of the first thermally conductive filler, 12-28 wt% of the second thermally conductive filler and 50-68 wt% of the third thermally conductive filler, based on the total weight of the composition.

In a yet further embodiment of the thermal interface material composition of the second aspect, the composition comprises about 7 wt% of the first thermally conductive filler, 26 wt% of the second thermally conductive filler and 60 wt% of the third thermally conductive filler, based on the total weight of the composition.

In yet a further embodiment of the thermal interface material of the second aspect, the first thermally conductive filler i) is Al₂O₃ having a non-spherical shape and a particle size distribution D₅₀ ranging from about 0.1-2 µm, the second thermally conductive filler ii) is Al₂O₃ having a spherical shape and a particle size distribution D₅₀ ranging from about 3-10 µm, and the third thermally conductive filler iii) is Al₂O₃ having a spherical shape and a particle distribution size D₅₀ ranging from about 40-150 µm.

In yet a further embodiment of the thermal interface material of the second aspect, the first thermally conductive filler i) is aluminium hydroxide [Al(OH)₃] having a non-spherical shape and a particle size distribution D₅₀ ranging from about 0.1-2 µm, the second thermally conductive filler ii) is Al₂O₃ having a spherical shape and a particle size distribution D₅₀ ranging from about 3-10 µm, and the third thermally conductive filler iii) is Al₂O₃ having a spherical shape and a particle distribution size D₅₀ ranging from about 40-150 µm.

In yet a further embodiment of the thermal interface material of the second aspect, the first thermally conductive filler i) is present at 0.5-10 wt% and is Al₂O₃ having a non-spherical shape and a particle size distribution D₅₀ ranging from about 0.1-2 µm, the second thermally conductive filler ii) is present at 10-35 wt% and is Al₂O₃ having a spherical shape and a particle size distribution D₅₀ ranging from about 3-10 µm, and the third thermally conductive filler iii) is present at 50-80 wt% and is Al₂O₃ having a spherical shape and a particle distribution size D₅₀ ranging from about 40-150 µm.

In yet a further embodiment of the thermal interface material of the second aspect, the first thermally conductive filler i) is present at 0.5-10 wt% and is aluminium hydroxide [Al(OH)₃] having a non-spherical shape and a particle size distribution D₅₀ ranging from about 0.1-2 µm, the second thermally conductive filler ii) is present at 10-35 wt% and is Al₂O₃ having a spherical shape and a particle size distribution D₅₀ ranging from about 3-10 µm, and the third thermally conductive filler iii) is present at 50-80 wt% and is Al₂O₃ having a spherical shape and a particle distribution size D₅₀ ranging from about 40-150 µm.

In yet a further embodiment of the thermal interface material of the second aspect, the first thermally conductive filler i) is present at 0.5-10 wt% and is Al₂O₃ having a non-spherical shape and a particle size distribution D₅₀ ranging from about 0.5-1.5 µm, the second thermally conductive filler ii) is present at 10-35 wt% and is Al₂O₃ having a spherical shape and a particle size distribution D₅₀ ranging from about 3-7 µm, and the third thermally conductive filler iii) is present at 50-80 wt% and is Al₂O₃ having a spherical shape and a particle distribution size D₅₀ ranging from about 50-90 µm.

In yet a further embodiment of the thermal interface material of the second aspect, the first thermally conductive filler i) is present at 0.5-10 wt% and is aluminium hydroxide [AI(OH)₃] having a non-spherical shape and a particle size distribution D₅₀ ranging from about 1-2 µm, the second thermally conductive filler ii) is present at 10-35 wt% and is Al₂O₃ having a spherical shape and a particle size distribution D₅₀ ranging from about 3-7 µm, and the third thermally conductive filler iii) is present at 50-80 wt% and is Al₂O₃ having a spherical shape and a particle distribution size D₅₀ ranging from about 50-90 µm.

Further provided herein are articles comprising the thermal interface material compositions provided above.

In one embodiment of the article, the article further comprises a battery module that is formed of one or more battery cells and a cooling unit, wherein, the battery module is connected to the cooling unit via the thermal interface material composition.

### DETAILED DESCRIPTION

Disclosed herein, according to a first aspect, are thermal interface materials (TIM) comprising a polymeric binder component and about 85-95 wt% of a mixture of spherically shaped and thermally conductive fillers, based on the total weight of the TIM composition. And based on the combined weight, the mixture of spherically shaped and thermally conductive fillers comprises about 15-40 wt% of a first spherically shaped and thermally conductive filler that has a particle size distribution D₅₀ ranging from about 0.1-20 µm and about 50-80 wt% of a second spherically shaped and thermally conductive filler that has a particle size distribution D₅₀ ranging from about 40-150 µm.

Also disclosed herein, according to a second aspect, are thermal interface material compositions comprising: a) a polymeric binder component, and b) about 85-95 wt% of thermally conductive fillers, with the total weight of the composition totaling to 100 wt%, and wherein, the thermally conductive fillers comprises, based on the combined weight thereof, i) about 0.5-10 wt% of a first thermally conductive filler that has a spherical or non-spherical shape and a particle size distribution D₅₀ ranging from about 0.1-2 µm, ii) about 10-35 wt% of a second thermally conductive filler that has a spherical shape and a particle size distribution D₅₀ ranging from about 3-10 µm, and iii) about 50-80 wt% of a third thermally conductive filler that has a spherical shape and a particle distribution size D₅₀ ranging from about 40-150 µm.

The polymeric binder component may be formed of any suitable polymeric materials. In one embodiment, the polymeric binder component is formed of elastomeric materials. Exemplary elastomeric material used herein include, without limitation, polyurethane, urea, epoxy, acrylate, silicone, silane modified polymers (SMP). In one embodiment, the polymeric binder component is formed of polyurethane.

In accordance with the present disclosure, the polymeric binder component may be present in the TIM composition at a level of 1-10 wt% or about 2-7 wt% based on the total weight of the TIM composition.

The term “spherically shaped” or “spherical” is used herein to refer to an isometric shape, i.e., a shape, in which, generally speaking, the extension (particle size) is approximately the same in any direction. In particular, for a particle to be isometric, the ratio of the maximum and minimum length of chords intersecting the geometric center of the convex hull of the particle should not exceed the ratio of the least isometric regular polyhedron, i.e. the tetrahedron.

Particle shape can be assessed by inspection under a scanning electron microscope. Spherical particles are those that appear spherical under a scanning electron microscope at 400- to 5500 X magnification, preferably at 5000 X magnification. Preferably the particles also have an aspect ratio of 1-1.2, preferably 1-1.1.

Particle shapes are often times defined by aspect ratios, which is expressed by particle major diameter/particle thickness. In some embodiments, the aspect ratio of the spherically shaped or spherical fillers ranges from about 1-3, or from about 1-2, more preferably 1-1.2.

The term “thermally conductive filler” is meant to refer to those filler materials that, in their pure form, has a thermal conductivity above 2 W/mK, as measured in according with ASTM 5470.

In addition, particle size distribution D₅₀, also known as the median diameter or the medium value of the particle size distribution, is the value of the particle diameter at 50% in the cumulative distribution. For example, if D₅₀=10 µm , then 50 volume% of the particles in the sample have an averaged diameter larger than 10 µm, and 50 volume% of the particles have an averaged diameter smaller than 10 µm.Particle size distribution D₅₀ of a group of particles can be determined using light scattering methods following, for example, ASTM B822-10 or ASTM B822-20, using water or acetone as suspending medium, or using laser diffraction methods following, for example, ASTM B822-10 or ASTM B822-20, or ISO 13320, using water or acetone as suspension medium. Preferably laser diffraction according to ISO 13320 is used, with water as the suspending medium.

The spherically shaped and thermally conductive fillers used herein may be formed of any suitable material, which include, without limitation, Al₂O₃, Al, Mg(OH)₂, MgO₂, SiO₂, Boron nitride. In the first aspect, the mixture of spherically shaped and thermally conductive fillers is comprised of at least two groups of fillers with distinct particle size distribution. That is, a first spherically shaped and thermally conductive filler having a particle size distribution D₅₀ ranging from about 0.1-20 µm or about 0.5-15 µm and a second spherically shaped and thermally conductive filler having a particle size distribution D₅₀ ranging from about 40-150 µm, about 40-120 µm, or about 40-90 µm.Based on the combined weight of the spherically shaped and thermally conductive fillers, the first spherically shaped and thermally conductive filler may be present at a level of about 15-40 wt%, or about 18-38 wt%, or about 20-35 wt% and the second spherically shaped and thermally conductive filler may be present at a level of about 50-80 wt%, or about 50-78 wt%, or about 53-75 wt% The first and second fillers might be formed of same or different thermally conductive materials. And each of the first and second filler also may be composed of one or more than one material. Moreover, the mixture of spherically shaped and thermally conductive fillers may further comprise addition group of spherically shaped and thermally conductive fillers having particle size distribution D₅₀ distinct from those of the first and second spherically shaped and thermally conductive fillers. In one embodiment, the mixture of spherically shaped and thermally conductive fillers spherical Al₂O₃ particles.

The spherically shaped and thermally conductive fillers used herein may be formed of any suitable material, which include, without limitation, Al₂O₃, Al, Mg(OH)₂, MgO₂, SiO₂, Boron nitride. In the second aspect, the mixture of spherically and non-spherical shaped and thermally conductive fillers is comprised of at least three groups of fillers with distinct particle size distribution. That is, i) a first thermally conductive filler that has a spherical or non-spherical shape and a particle size distribution D₅₀ ranging from about 0.1-2 µm, ii) a second thermally conductive filler that has a spherical shape and a particle size distribution D₅₀ ranging from about 3-10 µm, and iii) a third thermally conductive filler that has a spherical shape and a particle distribution size D₅₀ ranging from about 40-150 µm. The first, second and third fillers might be formed of same or different thermally conductive materials. And each of the first, second and third filler also may be composed of one or more than one material. Moreover, the mixture of spherically and non-spherically shaped and thermally conductive fillers may further comprise addition group of spherically shaped and thermally conductive fillers having particle size distribution D₅₀ distinct from those of the first and second spherically shaped and thermally conductive fillers. In one embodiment, the mixture of spherically shaped and thermally conductive fillers spherical Al₂O₃ particles.

Further, the spherically shaped and thermally conductive fillers may be surface treated with, for example, fatty acid, silane, zirconium-based coupling agent, titanate coupling agent, carboxylates, etc.

The mixture of spherically shaped and thermally conductive fillers may be present in the TIM composition at a level of about 85-95 wt% based on the total weight of the TIM composition.

Furthermore, the TIM compositions disclosed herein may optionally further comprise other suitable additives, such as, catalysts, plasticizers, stabilizers, adhesion promoters, fillers, colorants, etc. Such optional additives may be present at a level of up to about 10 wt%, or up to about 8 wt%, or up to about 5 wt%, based on the total weight of the TIM.

As demonstrated below by the examples, the addition of a mixture of spherically shaped thermally conductive fillers (15-40 wt% of those with particle size distribution ranging from about 0.1-20 µm and 50-80 wt% of those with particle size distribution ranging from about 40-150 µm) results in TIM with low viscosity and high conductivity.

As demonstrated below by the examples, according to the second aspect of the invention the addition of a mixture of spherically and non-spherically shaped thermally conductive fillers having a particle size distribution D₅₀ ranging from about 0.1-2 µm results in TIM with low viscosity and high thermal conductivity.

Further disclosed herein are battery pack systems in which a cooling unit or plate is coupled to a battery module (formed of one or more battery cells) via the TIM described above such that heat can be conducted therebetween. In one embodiment, the battery pack systems are those used in battery powered vehicles.

### EXAMPLES

### Materials

Amine-1 — tri-functional polyetheramine
Amine-2 — di-functional polyetheramine
Plasticizer — methylated rapseed oil;
Stabilizer — precipitated calcium carbonate obtained from Keyser & Mackay under the trade name Calofort™ SV;
Catalyst — 33% triethylenediamine dissolved in 67% dipropylene glycol obtained from Evonik under the trade name Dabco™ LV33;
Acrylate —ethoxylated trimethylolpropane triacrylate obtained from Sartomer;
STP — aliphatic silane-terminated urethane prepolymer obtained from Covestro under the trade name Desmoseal™ S XP 2636;
Prepolymer — a reaction product between aromatic toluene diisocyanate (TDI) based polyisocyanate prepolymer and cardanol;
Colorant — coloring paste obtained from Huntsman under the trade name Araldit DW 0134 Gruen;
Al₂O₃-s-1 — trimodulus spherical Al₂O₃ particles comprised of 20 wt% of particles with particle size distribution D₅₀ equal to 0.7 µm , 10 wt% of particles with particle size distribution D₅₀ equal to 5.9 µm, and 70 wt% of particles with particle size distribution D₅₀ equal to 79 µm, and an aspect ratio of less than 1.2;
Al₂O₃-P-1 - —trimodulus non-spherical Al₂O₃ particles comprised of 20 wt% of particles with particle size distribution D₅₀ equal to 0.7 µm , 10 wt% of particles with particle size distribution D₅₀ equal to 5.9 µm, and 70 wt% of particles with particle size distribution D₅₀ equal to 79 µm, and an aspect ratio of greater than 1.2;
ATH-1 — bimodally distributed non-spherical aluminum trihydroxide obtained which is comprised of particles with particle size distribution D₅₀ less than 10 µm and particles with particle size distribution D₅₀ greater than 50 µm, and an aspect ratio of greater than 1.2;
ATH-2 — monomodulus aluminum trihydroxide (non-spherical) with a particle size distribution D₅₀ equal to 2 µm, and an aspect ratio of greater than 1.2;
ATH-3 — monomodulus aluminum trihydroxide (non-spherical) with a particle size distribution D₅₀ equal to 50 µm, and an aspect ratio of greater than 1.2;
ATH-4 — monomodulus aluminum trihydroxide (non-spherical) with a particle size distribution D₅₀ equal to 1.5 µm, and an aspect ratio of greater than 1.2;
Al₂O₃-P-2 — monomodulus non-spherical Al₂O₃ particles with particle size distribution D₅₀ equal to 5 µm, and an aspect ratio of greater than 1.2;
Al₂O₃-P-3 — monomodulus non-spherical Al₂O₃ particles with particle size distribution D₅₀ equal to 70 µm, and an aspect ratio of greater than 1.2;
Al₂O₃-P-4 — non-spherical Al₂O₃ particles with a particle size distribution D₅₀ equal to 0.8 µm, and an aspect ratio of greater than 1.2;
Al₂0₃-s-2 — monomodulus spherical Al₂O₃ particles with particle size distribution D₅₀ equal to 5 µm, and an aspect ratio of less than 1.2;
Al₂O₃-s-3 - monomodulus spherical Al₂O₃ particles with a particle size distribution D₅₀ equal to 70 µm, and an aspect ratio of less than 1.2;
Al-s — monomodulus spherical Al particles with particle size distribution D₅₀ equal to 14 µm, and an aspect ratio of less than 1.2 which was obtained from Eckhart;
TiO₂ — titanium dioxide particles obtained from Kronos International Inc.;
Al₂O₃-s-4 — monomodulus spherical Al₂O₃ particles with a particle size distribution D₅₀ equal to 0.7 µm and an aspect ratio of less than 1.2;
Al-p-1 — monomodulus non-spherical Al particles with a particle size distribution D₅₀ equal to 8 µm, and an aspect ratio of greater than 1.2;
Al-p-2 — monomodulus non-spherical Al particles with particle size distribution D₅₀ equal to 80 µm, and an aspect ratio of greater than 1.2;

Particle size distribution was measured by laser diffraction according to ISO 13320, using water as suspending medium.

Particle shape was assessed by inspection under a scanning electron microscope. Spherical particles are those that appeared spherical under a scanning electron microscope at 5000 X magnification, and which had an aspect ratio of less than 1.2.

### Comparative Examples CE1-CE8 and Examples E1-E7, E8 and E9

In each of CE1-CE8 and E1-E7, E8 and E9 Part A and Part B were separately prepared by mixing the components listed in Table 1 (first liquid components, then solid components). The viscosity (using Anton-Paar NMC 202 rheometer) and thermal conductivity (by ASTM 5470) of Part A and Part B were measured and tabulated in Table 1. Thereafter, Part A and Part B were mixed at a 1:1 volume ratio using Speedmixer for 20 seconds to obtain the final thermal interface material (TIM). And the thermal conductivity of the TIM was measured and tabulated in Table 1.

As demonstrated herein, the addition of a mixture of spherically shaped thermally conductive fillers (15-40 wt% of those with particle size distribution ranging from about 0.1-20 µm and 50-80 wt% of those with particle size distribution ranging from about 40-150 µm), TIM with low viscosity and high conductivity were obtained.

Examples E8 and E9 are examples of the second aspect of the invention, comprising i) a first thermally conductive filler that has a spherical or non-spherical shape and a particle size distribution D₅₀ ranging from about 0.1-2 µm [Al₂O₃-p-4, D₅₀ 0.8 µm (Ex 8), ATH-4, D₅₀ 1.5 µm (Ex. 9)] ii) a second thermally conductive filler that has a spherical shape and a particle size distribution D₅₀ ranging from about 3-10 µm (Al₂O₃-s-2, D₅₀ 5 µm), and iii) a third thermally conductive filler that has a spherical shape and a particle distribution size D₅₀ ranging from about 40-150 µm (Al₂O₃-s-3, D₅₀ 70 µm).

Table 1

| | CE1 | CE2 | CE3 | CE4 | CE5 | CE6 | CE7 | CE8 | E1 | E2 | E3 | E4 | E5 | E6 | E7 | E8 | E9 |
|---|---|---|---|---|---|---|---|---|---|---|---|---|---|---|---|---|---|
| Composition (Part A, wt%) | | | | | | | | | | | | | | | | | |
| Amine-1 | 2.3 | 2.3 | 2.3 | 2.3 | 2.3 | 2.3 | 2.3 | 2.3 | 2.3 | 2.3 | 2.3 | | | 2.3 | 2.3 | 2.3 | 2.3 |
| Amine-2 | | | | | | | | | | | | 2.3 | | | | | |
| Water | | | | | | | | | | | | | 0.5 | | | | |
| Plasticizer | 4.1 | 4.1 | 4.1 | 4.1 | 4.1 | 4.1 | 4.1 | 4.1 | 4.1 | 4.1 | 4.1 | 4.1 | 5.9 | 4.1 | 4.1 | 4.1 | 4.1 |
| Stabilizer | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 |
| Catalyst | 0.075 | 0.075 | 0.075 | 0.075 | 0.075 | 0.075 | 0.075 | 0.075 | 0.075 | 0.075 | 0.075 | 0.075 | 0.075 | 0.075 | 0.075 | 0.075 | 0.075 |
| Al₂O₃-s-1 | | | | | | | | | | | 93.025 | 93.025 | 93.025 | | | | |
| Al₂O₃-p-1 | | 93.025 | | | | | | | | | | | | | | | |
| ATH-1 | | | | 93.025 | | | | | | | | | | | | | |
| ATH-2 | 27.5 | | | | | | | | | | | | | | | | |
| ATH-3 | 65.525 | | | | | | | | | | | | | | | | |
| Al₂O₃-p-2 | | | 27.5 | | | | | | | | | | | | | | |
| Al₂O₃-p-3 | | | 65.525 | | | | | | | | | | | | | | |
| Al₂O₃-s-2 | | | | | 12.5 | 27.5 | | 93.025 | 27.5 | 12.5 | | | | 23.025 | 25 | 25 | 25 |
| Al₂O₃-s-3 | | | | | 65.525 | 50.525 | 93.025 | | 65.525 | 65.525 | | | | 65 | 66025 | 66025 | 66.025 |
| Al-s | | | | | | | | | | 15 | | | | | | | |
| TiO₂ | | | | | | | | | | | | | | | 2 | | |
| Al₂O₃-s-4 | | | | | | | | | | | | | | 5 | | | |
| Al-p-1 | | | | | 15 | | | | | | | | | | | | |
| Al-p-2 | | | | | | 15 | | | | | | | | | | | |
| Al₂O₃-p-4 | | | | | | | | | | | | | | | | 2 | |
| ATH-4 | | | | | | | | | | | | | | | | | 2 |

| | | | | | | | | | | | | | | | | | |
|---|---|---|---|---|---|---|---|---|---|---|---|---|---|---|---|---|---|
| Property (Part A) | | | | | | | | | | | | | | | | | |
| Viscosity @ 10 s⁻¹ | N/D | N/D | N/D | N/D | N/D | N/D | N/D | N/D | 19.5 | 23 | 55.4 | 4.6 | 20.2 | 36.24 | 50.49 | 44.9 | 36.2 |
| Thermal Conductivity @ 3 mm gap (W/mK) | N/D | N/D | N/D | N/D | N/D | N/D | N/D | N/D | 3.82 | 3.53 | 4.13 | 3.5 | 3.40 | 3.34 | 3.49 | 3.90 | 3.89 |

| | | | | | | | | | | | | | | | | | |
|---|---|---|---|---|---|---|---|---|---|---|---|---|---|---|---|---|---|
| Composition (Part B wt%) | | | | | | | | | | | | | | | | | |
| Acrylate | | | | | | | | | | | | 2.6 | | | | | |
| STP | | | | | | | | | | | | | 2.6 | | | | |
| Prepolymer | 2.6 | 2.6 | 2.6 | 2.6 | 2.6 | 2.6 | 2.6 | 2.6 | 2.6 | 2.6 | 2.6 | | | 2.6 | 2.6 | 2.6 | 2.6 |
| Plasticizer | 5.4 | 5.4 | 5.4 | 5.4 | 5.4 | 5.4 | 5.4 | 5.4 | 5.4 | 5.4 | 5.4 | 5.4 | 5.4 | 5.4 | 5.4 | 5.4 | 5.4 |
| Stabilizer | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 |
| Colorant | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 |
| Al₂O₃-s-1 | | | | | | | | | | | 91.4 | 91.4 | 91.4 | | | | |
| Al₂O₃-p-1 | | 91.4 | | | | | | | | | | | | | | | |
| ATH-1 | | | | 91.4 | | | | | | | | | | | | | |
| ATH-2 | 23 | | | | | | | | | | | | | | | | |
| ATH-3 | 68.4 | | | | | | | | | | | | | | | | |
| Al₂O₃-p-2 | | | 23 | | | | | | | | | | | | | | |
| Al₂O₃-p-3 | | | 68.4 | | | | | | | | | | | | | | |
| Al₂O₃-s-2 | | | | | 23 | 8 | | 91.4 | 23 | 23 | | | | 30.9 | 30.9 | 30.9 | 30.9 |
| Al₂O₃-s-3 | | | | | 53.4 | 68.4 | 91.4 | | 68.4 | 53.4 | | | | 60 | 60 | 60 | 60 |
| Al-s | | | | | | | | | | 15 | | | | | | | |
| TiO₂ | | | | | | | | | | | | | | | 0.5 | | |
| Al₂O₃-s-4 | | | | | | | | | | | | | | 0.5 | | | |
| Al-p-1 | | | | | 15 | | | | | | | | | | | | |
| Al-p-2 | | | | | | 15 | | | | | | | | | | | |
| Al₂O₃-p-4 | | | | | | | | | | | | | | | | 0.5 | |
| ATH-4 | | | | | | | | | | | | | | | | | 0.5 |

| Property (Part B) | | | | | | | | | | | | | | | | | |
|---|---|---|---|---|---|---|---|---|---|---|---|---|---|---|---|---|---|
| Viscosity @ 10 s⁻¹ | N/D | N/D | N/D | N/D | N/D | N/D | N/D | N/D | 21.6 | 22 | 24.2 | 66.7 | 62.9 | 29.43 | 26.28 | 29.07 | 38.29 |
| Thermal Conductivity @ 3 mm gap (W/mK) | N/D | N/D | N/D | N/D | N/D | N/D | N/D | N/D | 2.87 | 305 | 3.31 | 3.23 | 3.21 | 2.7 | 2.51 | 2.68 | 308 |
| Property (Mixture of A+B (1:1)) | | | | | | | | | | | | | | | | | |
| Homogenous mixture | No | No | No | No | No | No | No | No | Yes | Yes | Yes | Yes | Yes | Yes | Yes | Yes | Yes |
| Thermal Conductivity @ 3 mm gap (W/mK) | N/A | N/A | N/A | N/A | N/A | N/A | N/A | N/A | 3.43 | 3.3 | 3.63 | 3.29 | 3.4 | 3.01 | 3.03 | 3.73 | 3.6 |

N/D: not determined as material is too viscous;
N/A: not applicable.

1. A thermal interface material composition comprising:
a) a polymeric binder component, and
b) about 85-95 wt% of a mixture of spherically shaped and thermally conductive fillers,
with the total weight of the composition totaling to 100 wt%,
and wherein, the mixture of spherically shaped and thermally conductive fillers comprises, based on the combined weight thereof, i) about 15-40 wt% of a first thermally conductive filler that has a spherical shape and a particle size distribution D₅₀ ranging from about 0.1-20 µm, and ii) about 50-80 wt% of a second thermally conductive filler that has a spherical shape and a particle distribution size D₅₀ ranging from about 40-150 µm.

2. The thermal interface material composition of claim 1, which comprises about 1-10 wt% of the polymeric binder component, based on the total weight of the composition.

3. The thermal interface material composition of claim 1, wherein, the first and second thermally conductive filler are independently selected from the group consisting of Al₂O₃, Al, Mg(OH)₂, MgO2, SiO₂, Boron nitride, and mixtures thereof.

4. The thermal interface material composition of claim 3, wherein, the first and second thermally conductive filler are Al₂O₃ particles.

5. The thermal interface material composition of claim 1, wherein, the first thermally conductive filler has a particle size distribution D₅₀ ranging from about 0.5-15 µm, and the second thermally conductive filler has a particle distribution size D₅₀ ranging from about 40-120 µm.

6. The thermal interface material composition of claim 5, wherein the second thermally conductive filler has a particle distribution size D₅₀ ranging from about 40-90 µm.

7. The thermal interface material composition of claim 1, which comprises about 18-38 wt% of the first thermally conductive filler and about 50-78 wt% of the second thermally conductive filler, based on the total weight of the composition.

8. The thermal interface material composition of claim 7, which comprises about 20-35 wt% of the first thermally conductive filler and about 53-75 wt% of the second thermally conductive filler, based on the total weight of the composition.

9. An article comprising the thermal interface material composition recited in claim 1.

10. The article of claim 10, which further comprises a battery module that is formed of one or more battery cells and a cooling unit, wherein, the battery module is connected to the cooling unit via the thermal interface material composition.

11. A thermal interface material composition comprising: a) a polymeric binder component, and b) about 85-95 wt% of thermally conductive fillers, with the total weight of the composition totaling to 100 wt%, and wherein, the thermally conductive fillers comprises, based on the combined weight thereof, i) about 0.5-10 wt% of a first thermally conductive filler that has a spherical or nonspherical shape and a particle size distribution D₅₀ ranging from about 0.1-2 µm, ii) about 10-35 wt% of a second thermally conductive filler that has a spherical shape and a particle size distribution D₅₀ ranging from about 3-10 µm, and iii) about 50-80 wt% of a third thermally conductive filler that has a spherical shape and a particle distribution size D₅₀ ranging from about 40-150 µm.

12. The thermal interface material of claim 11, wherein the first thermally conductive filler i) has a particle size distribution D₅₀ ranging from about 0.5-5 µm, more preferably 0.6-2 µm.

13. The thermal interface material of claim 11, wherein the second thermally conductive filler ii) has a particle size distribution D₅₀ ranging from about 3-10 µm, preferably 3-6 µm.

14. The thermal interface material of claim 11, wherein the third thermally conductive filler iii) has a particle size distribution D₅₀ ranging from about 40-150 µm, preferably 50-100 µm, more preferably 55-85 µm.

15. The thermal interface material composition of claim 11 , which comprises about 1-10 wt% of the polymeric binder component, based on the total weight of the composition.

16. The thermal interface material composition of claim 11 , wherein, the first, second and third thermally conductive filler are independently selected from the group consisting of Al₂O₃, Aluminium hydroxide, Mg(OH)₂, MgO₂, SiO₂, ZnO, TiO₂, Boron nitride, and mixtures thereof.

17. The thermal interface material composition of claim 11 , wherein, the first conductive filler is aluminium hydroxide, and the second and third thermally conductive filler are Al₂O₃ particles.

18. The thermal interface material composition of claim 11 , wherein the first conductive filler i) is present at 1-7 wt%, preferably 2-5 wt%, based on the total weight of the composition.

19. The thermal interface material composition of claim 11 , wherein the second conductive filler ii) is present at 10-30 wt%, preferably 12-28 wt%, based on the total weight of the composition.

20. The thermal interface material composition of claim 11 , wherein the third conductive filler iii) is present at 50-75 wt%, preferably 50-68 wt%, based on the total weight of the composition.

21. The thermal interface material of claim 1 , wherein particle size distribution D₅₀ was measured by laser diffraction according to ISO 13320, using water as suspending medium.

22. The thermal interface material of claim 1, wherein spherical particles are those that appear spherical under a scanning electron microscope at 400- to 5500 X magnification, preferably at 5000 X magnification.

23. The thermal interface material of claim 1, wherein spherical particles have an aspect ratio of 1-1.2, preferably 1-1.1.

24. A battery module that is formed of one or more battery cells and a cooling unit, wherein, the battery module is connected to the cooling unit via the thermal interface material composition of claim 1.
